(19) United States
(12) Patent Application Publication
(10) Pub. No.: US 2008/0292891 A1
(43) Pub. Date: Nov. 27, 2008

(54) ELECTROMAGNETIC WAVE SHIELDING SHEET

(75) Inventors: Hiroshi Tsutagaya, Gunma (JP); Takashi Ishiguro, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd, Tokyo (JP)

(21) Appl. No.: 12/104,149

(22) Filed: Apr. 16, 2008

(30) Foreign Application Priority Data
Apr. 17, 2007 (JP) JP 2007/108731

(51) Int. Cl. B32B 15/00; B32B 9/00; B32B 37/02

(52) U.S. Cl. 428/457; 428/411.1; 156/281

(57) ABSTRACT

An electromagnetic wave shielding sheet having a high shielding effect for electromagnetic waves and capable of suppressing secondary emission causing noises without using GND connection, in which the electromagnetic shielding sheet includes a laminate film on a paper substrate, the laminate film has a laminate structure where an adhesive layer having adhesion property, a resistor layer and an insulator are laminated, the resistivity of the insulator is set to about 10⁶ Ω/cm or higher and the resistance value of the resistor layer is set to about 10Ω to 300Ω, so that secondary emission can be decreased while keeping a high shielding effect.

### BACKGROUND OF THE INVENTION

1. Field of the Invention

The present invention concerns an electromagnetic wave shielding sheet which is optimal for shielding electromagnetic waves emitted from an electronic equipment or the like to the outside, or electromagnetic waves from intruding from the outside.

2. Description of the Related Technology

As internal wirings for electronic equipments such as mobile telephones, digital cameras, liquid crystal TV, and printers, FPC (flexible printing circuits) and FFC (flexible flat cables) have been used. For electric wirings such as FPC and FFC or electronic parts such as LSI mounted to the inside of the electronic equipments, prevention of leakage or countermeasure for noises of electromagnetic waves have been intended by covering them with films having an electromagnetic wave shielding effect. Existent electromagnetic wave shielding sheets have a structure of forming a conductor layer (for example, metal layer) on the surface of a substrate such as a resin film and absorbing and shielding electromagnetic waves by the conductor layer.

For example, as the electromagnetic wave shielding technique, “electromagnetic shielding film and shielding structure using the same” in JP-A No. 6-97694, “electromagnetic shielding sheet and electronic equipment” in JP-A No. 2005-64266 have been known. Further, JP-A No. 2006-332362 discloses an electromagnetic absorption sheet in which an electromagnetic wave absorbing material such as a magnetic material or carbon is dispersed in a resin having flexibility such as a synthesis rubber as “method of forming electric wave absorbing portion, electronic wave absorbing sheet, radiofrequency equipment and electric wave absorbing portion forming device”.

However, in the existent technique, the resistance of the conductor layer is excessively low and, although a shielding effect by reflection can be expected, the absorbing effect for electromagnetic waves is low to sometimes cause secondary emission of noises. For preventing the problem, the conductor layer is sometimes connected to GND or earth, but this requires a space and a structure therefor, is not convenient to use, requires much labor, as well as increases the cost. Further, no good shielding effect can be obtained effectively in a case of an electric wave absorption sheet having no or low conductivity.

### SUMMARY OF CERTAIN INVENTIVE ASPECTS

Certain inventive aspects provide an electromagnetic wave shielding sheet having a high shielding effect for electromagnetic waves and capable of suppressing secondary emission that causes noises without using GND connection.

One inventive aspect relates to an electromagnetic wave shielding sheet having a resistor layer and an adhesion layer having an adhesion property that enables bonding on one main surface of the resistor layer, in which the resistance value of the resistor layer is within a range from about 10Ω to 300Ω when measured for a distance of 98 mm at the center of the width for 100 mm length and 2 mm width.

Another inventive aspect relates to an electromagnetic wave shielding sheet having a resistor layer, an adhesion layer having an adhesion property that enables bonding on one main surface of the resistor layer, and an insulator layer formed on the other main surface of the resistor layer, in which the resistance value of the resistor layer is within a range from about 10Ω to 300Ω when measured for a distance of 98 mm at the center of the width for 100 mm length and 2 mm width.

Therefore, good electric wave absorbing characteristics of decreasing secondary emission can be obtained while keeping a high shielding effect. Further, the absorbing characteristics can be improved further.

In one main embodiment, the resistivity of the insulator formed on the other main surface of the resistor layer is 106 Ω/cm or more. In another embodiment, the adhesion layer is formed of a thermoplastic resin or a thermosetting resin. In a further embodiment, the resistor layer is formed of a thin aluminum film. In a still further embodiment, the thickness of the thin aluminum film is from about 100 to 500 Å.

The invention also includes wirings such as FPC or FFC having the sheet attached thereto, as well as electronic equipment components and/or enclosures having the sheet attached thereto such as computers, cell phones, digital cameras and the like. The invention can also be implemented as clothing having the sheet affixed thereto. All of these embodiments may have the sheet affixed thereto with an adhesive layer, or with other methods.

The foregoing and other objects, as well as features and advantages of the invention will become apparent with reference to the following descriptions and the accompanying drawings.

### DESCRIPTION OF THE ACCOMPANYING DRAWINGS

FIG. 1A is a cross sectional view showing a laminate structure of an electromagnetic wave shielding sheet according to Example 1 of one embodiment;

FIG. 1B is view showing a method of measuring a resistance value;

FIG. 2 is a graph showing the result of a test for the comparison of characteristics between an electromagnetic wave shielding sheet of Example 1 and that of a comparative example, in which FIG. 2A is graph showing the absorption characteristics and FIG. 2B is a view showing transmission characteristics; and

FIG. 3 is a plan view showing an application example of an electromagnetic wave shielding sheet of one embodiment.

### DETAILED DESCRIPTION OF CERTAIN EMBODIMENTS

Preferred embodiments of the invention are to be described specifically based on examples.

### Example 1

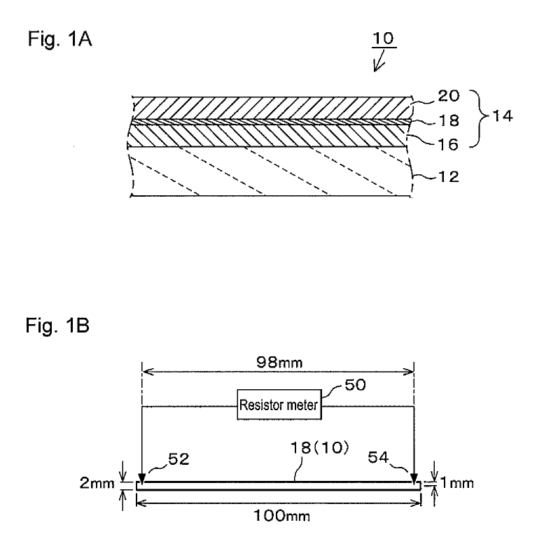

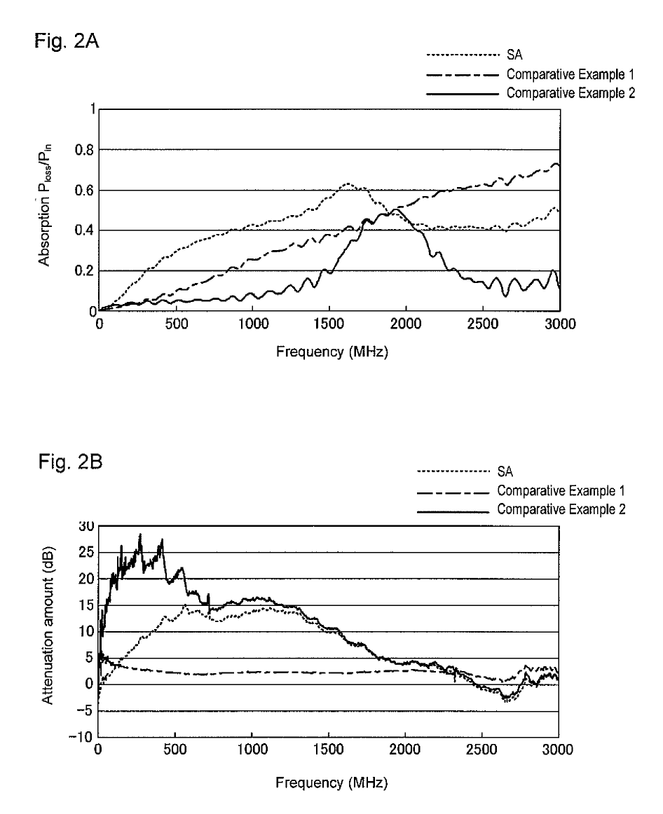

At first, Example 1 of one embodiment is to be described with reference to FIG. 1 and FIG. 2. FIG. 1A is a cross sectional view showing the laminate structure of an electromagnetic wave shielding sheet of this example and FIG. 1B is a view showing the method of measuring a resistance value. FIG. 2 is a view showing the result of a test for comparing characteristics between an electromagnetic wave shielding sheet of this example and that of a comparative example in which FIG. 2A is a view showing absorption characteristics and FIG. 2B is a view showing transmission characteristics.

A structure of this example is to be described with reference to FIG. 1A. The electromagnetic wave shielding sheet of this example has a shielding function as a noise countermeasure of electronic equipments, for preventing leakage of electromagnetic waves to the outside or for preventing or decreasing the effect of electromagnetic waves from the outside. Specifically, the shielding sheet is disposed so as to cover the surface of wiring members such as FPC (flexible printing circuits) or FFC (flexible flat cables) or electronic parts such as LSI. Shielding referred to herein includes both the absorption function and the reflection function for electromagnetic waves. As shown in FIG. 1A, an electromagnetic wave shielding sheet 10 of this example has a structure of laminating a paper substrate (release paper) 12, and a lamination film 14. The lamination film 14 has a laminate structure formed by bonding an adhesive layer 16, a resistor layer 18, and an insulator layer 20 to each other. While the paper substrate 12 is disposed such that the electromagnetic wave shielding sheet 10 can be easily cut into desired size and shape, but the purpose of the invention can be attained without using the paper substrate and the paper substrate may be disposed optionally.

For the adhesive layer 16, while a commercially available ethylene-methylmethacrylate copolymer resin (EMMA) film is used in the example as a material showing an adhesion property by applying heat, other various kinds of materials having a thermal adhesion property, for example, a polyimide resin or CPP (not oriented polypropylene) may also be used depending on the underlying paper substrate 12. In this example, an adhesive layer 16 having a low temperature heat sealing property at about 30 μm thickness was formed by using EMMA.

As the adhesive layer, a double-sided adhesive tape may be used to provide a structure of peeling a release tape on one side and bonding the laminate film of the resistor layer and the insulator layer. In this structure, a not yet peeled release tape has a role as the paper substrate. Accordingly, when the electromagnetic wave shielding sheet 10 is adhered to an electronic equipment, it can be adhered while peeing the release tape as a substitute for the paper substrate.

Then, as the resistor layer 18, a thin metal film formed, for example, by vapor deposition or plating is used. In this example, a thin aluminum film formed by vapor depositing aluminum is used as the resistor layer 18. The resistance value of the thin aluminum film is adjusted within a range from about 10Ω to 300Ω. This is because the absorption performance for the electromagnetic waves is worse in a case where the resistance value is lower than 10Ω and, on the other hand, the transmission performance of the electromagnetic waves is worse in a case where the resistance value is higher than 300Ω. The resistance value was measured as shown in FIG. 1B, by connecting a resistor meter 50 at terminals 52, 54 to the resistor layer 18 on the electromagnetic wave shielding sheet 10 of 100 mm length and 2 mm width. The top ends of the terminals 52, 54 are situated substantially at the center for the width of the electromagnetic wave shielding sheet 10 and the distance between the terminals 52 and 54 is 98 mm. Another way to express the advantageous resistive property of the layer is to define the “sheet resistance” of the layer as the resistivity of the layer material divided by the thickness of the layer material, which is a value also known as “ohms per square.” A 10 to 300 ohm resistance will be produced using the measurement process described above if the sheet resistance of the film is about 0.2 to about 6.1 ohms.

Then, the thickness of the thin aluminum film is set, preferably, from about 200 to 400 Å and the thickness can optionally be varied properly so long as it is within a range from about 100 to 500 Å. In this example, the thin aluminum film is formed by sputtering such that the thickness is 400 Å. The range for the thickness corresponds to the range for the resistance value. As described above, by decreasing the thickness of the resistor layer 18, it can be acted as a resistor body with the resistance value of the resistor layer 18 being adjusted to improve the absorbing performance for the electromagnetic waves. Instead of the thin aluminum film described above, also an alloy comprising aluminum as a main ingredient can provide same function and effect as those of the thin aluminum film so long as the resistance value is within a range from about 10Ω to 300 Ω.

An insulator layer 20 is formed on the other main surface of the resistor layer 18. In this example, a CPP (not-oriented polypropylene) film of 20 μm thickness is used as the insulator layer 20, but other insulation materials may also be used. For example, organic materials such as PET, PE, PI, etc. can also be used, or it may be an inorganic film formed of SiO₂ coating or SiN. The insulator layer 20 can be formed by a method such as vapor deposition or sputtering, as well as by a known wet process. The resistivity of the insulator layer described above is about 10⁶ Ω/cm or higher. This is because resistivity of lower than 10⁶ Ω/cm does not conform to the safety standards in the relevant industrial field. Further, this is defined so also in that the insulative property is not lost by aging during use or for preventing disadvantages such as short-circuit in a case of mounting wirings thereon.

The laminate film 14 as described above is formed, for example, by forming a resistor layer 18 such as a thin aluminum film by vapor deposition on the main surface of the insulator layer 20 and then bonding the adhesive layer 16 thereto by dry lamination. Then, they are cut into desired shape and size and used, for example, being adhered, for example, to a portion of a flexible cable at the position on the signal input side.

Then, referring to the operation of this example, a portion of electromagnetic waves intruding into the laminate film 14 is at first reflected on the resistor layer 18. Then, not reflected electromagnetic waves are incident to the resistor layer 18 and an eddy current flows due to the incidence of the electromagnetic waves to the resistor layer 18, which generates ohmic heating by the resistor layer 18 and, as a result, electromagnetic waves are absorbed.

As described above, according to the electromagnetic wave shielding sheet 10 of the basic structure of this example, the lamination film 14 comprising the adhesive layer 16, the resistor layer 18, and the insulator layer 20 is formed, the resistivity of the insulator layer 20 is set to 10⁶Ω/cm or higher, and the resistance value of the resistor layer 18 is defined within a range from 10Ω to 300Ω. Accordingly, good electric wave absorbing characteristics by decreasing the secondary emission that may cause noises can be obtained without GND connection while keeping a shielding effect. Further, since the resistor layer is acted as a resistor body with the resistance value being increased by decreasing the thickness of the resistor layer 18, a sheet having shielding characteristics comparable with those of the existent shielding film can be manufactured at a low cost, as well as the thickness of the electromagnetic wave shielding sheet 10 can be decreased.

### Experimental Example

Then, samples were manufactured for this example and a comparative example and description is to be made for an experimental example of comparing the absorption characteristics and the transmission characteristics. In this experimental example, the electromagnetic wave shielding sheet 10 described above was used as a sample SA.

Further, for Comparative Example 1, a noise suppressing sheet formed by sheeting a composite magnetic material prepared by dispersing and mixing 65% by weight of a flat powder of a sendust type metal magnetic material (Si 9.6 wt %, Al 15.5 wt %, and the balance of Fe) in a polymer resin on the upper surface of a commercially available PET film was used. For Comparative Example 2, a commercially available electromagnetic wave shielding film of a structure having an anisotropically conductive adhesive layer (17 μm) on the upper surface of a PET protection film (120 μm), a thin metal film layer (0.1 μm) on the upper surface of the adhesive layer, an insulation layer (5 μm) comprising a soft and flexible resin layer and an abrasion resistant resin layer on the upper surface of the thin metal film layer, and a PET transfer film (50 μm) on the upper surface of the insulation film was used.

For each of the example and the comparative examples, a test sample sized 50 mm length×50 mm width was used.

FIG. 2A is a graph showing the absorption characteristics of electromagnetic waves in which the abscissa represents a frequency (MHz), and the ordinate represents an absorption ratio (Pₗₒₛₛ/Pᵢₙ). The measuring method for the absorption characteristics is according to Transmission attenuation power ratio of IEC 62333-2 standards. Further, FIG. 2B is a graph showing the transmission characteristics of electromagnetic waves in which the abscissa represents a frequency (MHz) and the ordinate represents an attenuation amount (dB). The measuring method for the transmission characteristics is according to Inter-decoupling ratio of IEC 62333-2 standards. In both FIG. 2A and FIG. 2B, a dotted line represents a sample SA (electromagnetic shielding sheet 10), a dotted chain represents Comparative Example 1, and a solid line represents Comparative Example 2, respectively.

At first, as shown in FIG. 2A, the absorption ratio increases in sample SA to more than that of Comparative Examples 1 and 2 in a frequency region of 2 GHz or lower. From the result, it could be confirmed that the lamination structure utilizing the laminate film 14 of this example had a high absorption efficiency.

On the other hand, for the attenuation amount, the sample SA shows a more attenuation amount than Comparative Example 1 and a less attenuation amount than Comparative Example 2 as shown in FIG. 2B in a range of 2 GHz or lower. In a case where the attenuation amount is excessively large, the electromagnetic waves are confined in the electronic equipment to cause disturbance in the signal waveforms. On the other hand, in a case where the attenuation amount is excessively small, electromagnetic waves are emitted from the electronic equipment to the outside, and the shielding effect is low. In view of the above, it is considered that the electromagnetic shielding sheet 10 of this example has extremely excellent attenuation characteristics.

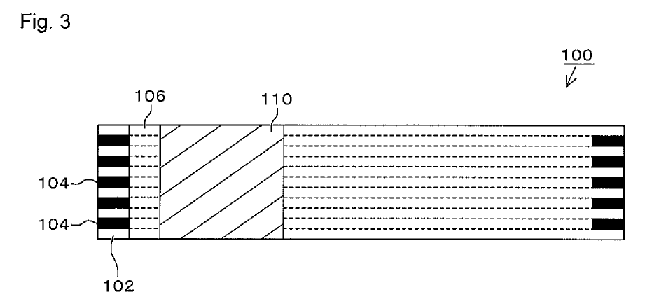

FIG. 3 shows an example of application use of this example. An FFC 100 has a structure in which a conductor pattern 104 is put between flexible insulation sheets 102, 106. The electromagnetic shielding sheet 110 shown in the example described above is disposed so as to cover the FFC 100. Since a disadvantage such as increase of the noises is caused in a case where the FFC 100 is covered entirely, it is covered for such a range as capable of obtaining a good electromagnetic wave shielding effect.

The present invention is not restricted to the example described above but can be modified variously within a range not departing the gist of the invention. For example, certain embodiments also include the following:

(1) The shape and the size shown in the example show one example which may be properly modified optionally. Further, also the thickness and the material in the example show an example which can be modified properly within the range shown in the example described above so long as identical effects can be provided.

(2) The paper substrate is also an example which may be disposed optionally.

(3) The manufacturing step described above is also an example, which may be changed properly so as to provide identical effects.

(4) In the example described above, the electromagnetic wave shielding sheet of one embodiment is used for covering wirings such as FPC or FFC. However, this is also an example that the embodiment is applicable also to electronic equipments, in general, that emit electromagnetic wave noises. For example, the shielding sheet can be disposed to PC, mobile telephones, digital cameras, as well as can be utilized for shielding electromagnetic waves from the outside. For example, by putting on clothes that utilize the electromagnetic wave shielding sheet of one embodiment, it is applicable also to prevent electromagnetic wave disorders to pace makers. In addition, the embodiment is applicable also to application uses, in general, for preventing leakage or intrusion of electromagnetic waves.

According to one embodiment, in a laminate film structure having a resistor layer, an adhesive layer having adhesion property and bonded to one main surface of the resistor layer each other, when the resistance value of the resistor layer is set from about 10Ω to 300Ω as measured for a distance of 98 mm at the center of the width for 100 mm length and 2 mm width. Accordingly, secondary emission can be decreased while keeping the high shielding effect. Further, these embodiments are applicable also to the application use of the electromagnetic shielding sheet. Particularly, it is suitable to the application use of shielding electromagnetic waves at high density for electronic equipments such as mobile telephones.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. An electromagnetic wave shielding sheet comprising a resistor layer and an adhesive layer adhering to one main surface of the resistor layer, wherein the resistance value of the resistor layer is within a range from about 10Ω to 300Ω when measured for a distance of 98 mm at the center of the width for 100 mm length and 2 mm width.

2. The electromagnetic wave shielding sheet according to claim 1, further comprises an insulator layer formed on the other main surface of the resistor layer, in which the resistivity of the insulator layer is about 10⁶ Ω/cm or higher.

3. The electromagnetic wave shielding sheet according to claim 1, wherein the adhesive layer is formed of a thermoplastic resin or a thermo-setting resin.

4. The electromagnetic wave shielding sheet according to claim 1, wherein the resistor layer is a thin film comprising aluminum as a main ingredient.

5. The electromagnetic wave shielding sheet according to claim 4, wherein the thickness of the thin film comprising aluminum as the main ingredient is from about 100 to 500 Å.

6. A method of making an electromagnetic wave shielding sheet, the method comprising:
forming a resistor layer on an insulator layer by vapor deposition, wherein the resistance value of the resistor layer is within a range from about 10Ω to 300Ω when measured for a distance of 98 mm at the center of the width for 100 mm length and 2 mm width; and
bonding an adhesive layer to the resistor layer by dry lamination.

7. The method according to claim 6, wherein the resistivity of the insulator layer is about 10⁶ Ω/cm or higher.

8. The method according to claim 6, wherein the adhesive layer is formed of a thermoplastic resin or a thermo-setting resin.

9. The method according to claim 6, wherein the resistor layer is a thin film comprising aluminum as a main ingredient.

10. The method according to claim 9, wherein the thickness of the thin film comprising aluminum as the main ingredient is from about 100 to 500 Å.

11. The method according to claim 6, wherein the resistor layer is located between the insulator layer and the adhesive layer.

12. An electromagnetic wave shielding sheet comprising a resistor layer and an adhesive layer adhering to one main surface of the resistor layer, wherein the resistor layer has a sheet resistance of about 0.2 to about 6.1 ohms.
